(19) United States
(12) Patent Application Publication
(10) Pub. No.: US 2018/0330394 A1
(43) Pub. Date: Nov. 15, 2018

(54) PAYMENT-LINKED PROMOTION PROCESSING SYSTEM AND METHOD THEREOF

(71) Applicant: Ki-won NAM, Seoul (KR)

(72) Inventor: Ki-won NAM, Seoul (KR)

(21) Appl. No.: 15/775,760

(22) PCT Filed: Nov. 11, 2016
(86) PCT No.: PCT/KR2016/013013

§ 371 Date: May 11, 2018

(30) Foreign Application Priority Data
Nov. 11, 2015 (KR) 10-2015-0158489

(51) Int. Cl. G06Q 30/02; G06Q 20/12

(52) U.S. Cl. CPC G06Q 30/0219; G06Q 30/0222; G06Q 30/0257; G06Q 20/12

(57) ABSTRACT

The present invention relates to a payment-linked promotion processing system and a method thereof, and the purpose of the present invention is to provide a payment-linked promotion processing system and a method thereof in which affiliates set to provide a fixed discount rate every time a sale occurs are classified for each discount rate; and a discount rate that is provided each time when a user purchases a product is accumulated to use as a financial resource, and purchasers can competitively select and determine the discount rate by themselves in real-time until when the predetermined accumulated discount rate is entirely exhausted, thereby inducing rapid consumption promotion by allowing sellers to process a discount on the determined discount rate.

### TECHNICAL FIELD

The present invention relates to a payment-linked promotion processing system and a method thereof, and more particularly, to a payment-linked promotion processing system and a method thereof in which affiliates set to provide a fixed discount rate every time a sale occurs are classified for each discount rate; and a discount rate that is provided each time when a user purchases a product is accumulated to use as a financial resource, and purchasers can competitively select and determine the discount rate by themselves in real-time until when the predetermined accumulated discount rate is entirely exhausted, thereby inducing rapid consumption promotion by allowing sellers to process a discount on the determined discount rate.

### BACKGROUND ART

As well known in the art, domestic and overseas online markets are rapidly growing, and the online market may be largely divided into an online advertisement market and an online shopping market.

The online advertisement market is indirectly related to the shopping market because it eventually advertises a company or products. However, when distinguishing the online market, it is classified as a pure online advertisement market and a shopping market.

Major marketing in the online advertisement market is largely performed in two directions: that is, in a direction of how many customers will be exposed to an advertisement, and a direction of how effective an advertisement exposure is to potential consumers.

Therefore, such an online advertisement market and a shopping market ultimately aim to expose an advertisement and shopping information to more customers, thus to induce them to purchase products. For this purpose, these markets introduce various advertisement techniques and shopping activation techniques.

The advertisement technique or the shopping activation technique is a typical method for providing an accumulated money to the customer, and is a method for providing a predetermined accumulated money to a customer who accesses an advertisement or purchases a product, thereby further increasing the number of times an advertisement is accessed, and further facilitating purchases of products.

However, in the above-described conventional techniques, the respective customers do not feel a special merit because the accumulated money allocated to the individual customers is very small. As a result, these techniques do not help a seller who wants to perform marketing through an advertisement or promote shopping.

Thus, in the conventional techniques, the seller expends a lot of promotional costs to advertise or sell a product, but it is difficult to achieve effective promotion or sale of the product.

The above-described advertising method has the same problem even in off-line marketing. For example, in a case of a coupon provided to a user at the time of purchasing an item in offline marketing, it may be necessary to accumulate 10 coupons to get a product cost one time freely provided by the seller. However, affiliates provide 10% of their sales as a promotional cost, which is a huge financial burden. In addition, there is a problem that the promotion is advantageous to the user, but does not give a motivation to promptly promote consumption.

### DISCLOSURE

### Technical Problem

In consideration of the above-mentioned circumstances, it is an object of the present invention to provide a payment-linked promotion processing system and a method thereof in which affiliates set to provide a fixed discount rate every time a sale occurs are classified for each discount rate; and a discount rate that is provided each time when a user purchases a product is accumulated to use as a financial resource, and purchasers can competitively select and determine the discount rate by themselves in real-time until when the predetermined accumulated discount rate is entirely exhausted, thereby inducing rapid consumption promotion by allowing sellers to process a discount on the determined discount rate.

### Technical Solution

In order to accomplish the above-described objects, according to an aspect of the present invention, there is provided a payment-linked promotion processing system including: a user terminal 2 configured to allow a user to participate in a real-time discount rate selection service every time the user pays a price of a product, generate a selection signal for selecting a specific discount rate desired by the user to a promotion processing server 10 after participating in the real-time discount rate selection service until when an accumulated discount rate is exhausted, and allow the user to confirm information on discount rate processing; an affiliate terminal 6 configured to set information in the promotion processing server 10 so as to provide a predetermined percentage of the price of the product as a financial resource of the discount rate when the user pays the price of the product; and the promotion processing server 10 configured to receive information on what percentage of the discount rate is provided as a financial resource of the real-time discount rate selection service when a sale occurs from the affiliate terminal 6 occurs and register the received information therein, perform processing of the real-time discount rate selection service of the user in real time, receive a selection signal for a specific discount rate of the user to pay the discount rate to the user, subtract an amount as much as the paid discount rate from a total accumulated discount rate, and provide information on a remaining discount rate.

Preferably, the selection signal for the discount rate of the user is set in the promotion processing server 10 so as to be generated before the payment for the price of the product.

Preferably, the user terminal 2 or the affiliate terminal 6 transmit payment information of the user to the promotion processing server 10.

Preferably, the user terminal 2 includes a promotion information interface application 4 installed therein to be automatically connected to the promotion processing server at the time of activating, and configured to input payment information for a specific product, generate a selection signal for the specific discount rate, and receive information on whether the discount rate is obtained from the promotion processing server 10 and output the received information.

Preferably, the real-time discount rate selection service is automatically processed so that the discount rate (or discount cost) that can be selected by the user is automatically and constantly decreased over time, and the total accumulated discount rate is decreased according to selection of other users.

Preferably, the real-time discount rate selection service is provided so as to select a specific number of products instead of the total accumulated discount rate.

Preferably, the promotion processing server 10 previously registers a plurality of backup promotion data for financial resource exhaustion for each selectable discount rate, so as to provide the real-time discount rate selection service to the user, and in this state, when the user participates in the real-time discount rate selection service, randomly extracts any one backup promotion data to apply it to the user.

Preferably, the promotion processing server 10 processes so that a plurality of users participate in the discount rate selection service at a predetermined time.

Preferably, the promotion processing server 10 includes a game group manager 26 configured to classify the backup promotion data for financial resource exhaustion according to information on what percentage of the discount rate is provided as a financial resource by the affiliates of a company and what price of a payment amount paid by the user at the time of payment of the user, and previously register the classified backup promotion data.

Preferably, the promotion processing server 10 includes: a communication module 16 configured to communicate with the user terminal 2, the affiliate terminal 6, or the payment processing server 8; an application information processor 18 configured to manage identification information of the promotion information interface application 4 installed in the user terminal 2, and process information on participation of the service and payment information of the user; a user selection signal receiver 20 configured to receive the selection signal for the specific discount rate of the user when participating in the service; a remaining discount rate recalculator 22 configured to perform a recalculation on an entire remaining accumulated discount rate according to a discount rate selected by the user; a backup promotion data manager 24 configured to register the number of users who select the discount rates by matching with each discount rate, and manage backup promotion data registered so as to be matched with the remaining accumulated discount rate for each discount rate; and a controller 36 configured to, when requesting the real-time discount rate selection service from the user, extract any one promotional backup data, perform processing of changing the remaining accumulated discount rate over time as the promotional backup data, and control so as to pay the discount rate by determining whether the remaining accumulated discount rate is present at the time of receiving information on the discount rate selected by the user.

Preferably, the promotion processing server 10 receives processing information on the payment amount of the affiliate from a payment processing server 8 which is provided in a credit card company or a financial company to perform payment processing of the affiliates, by interworking with the payment processing server 8.

Preferably, the promotion processing server 10 further includes: a backup promotion data update processor configured to separately collect information on the discount rate selected by the user, and generate and register new backup promotion data when performing the service through each backup promotion data.

Preferably, the promotion processing server 10 further includes: a discount rate processor for each case configured to: perform blind processing for hiding information on the remaining accumulated discount rate in a specific section of the backup promotion data; process so as to guarantee a predetermined minimum discount rate when the user generates a selection signal in the blind processing section; or process so as to output a news or an advertisement while hiding the information on the remaining accumulated discount rate in the specific section of the backup promotion data; and process so as to guarantee the predetermined minimum discount rate when the user generates the selection signal in the processing section.

Preferably, the promotion processing server 10 further includes: an advertisement data manager 32 configured to manage news or advertisement data so as to output a news or an advertisement while hiding the information on the remaining accumulated discount rate in the specific section of the backup promotion data.

Preferably, the promotion processing server 10 further includes: a discount rate processor for each section 34 configured to process so as to automatically exhaust a predetermined discount rate (or discount cost) for each specific discount section.

Preferably, the promotion processing server 10 calculates access costs for an advertisement output area 40 so as to be included in accumulated discount costs.

Preferably, the backup promotion data are promotion data in the past for the desired discount rates selected by a plurality of users participating in the same time zone, so that the discount rate that can be selected by the users is changed over time and the remaining accumulated discount rate is decreased.

Preferably, when the user selects a specific discount rate, if the number of users who have already selected the discount rate exceeds the number of past backup promotion data, the promotion processing server 10 processes the backup promotion data so that the number of users matched with every higher discount rate is gradually decreased one by one.

Preferably, the promotion processing server 10 processes to extract any one backup promotion data whose processing has not been completed according to a payment order of the users, and apply it to the discount rate selection service of the user.

According to another aspect of the present invention, there is provided a method of processing payment-linked promotion, including: a) activating a promotion information interface application 4 of a user terminal 2 to be automatically connected to a promotion processing server 10; b) transmitting affiliate information and purchase product information to the promotion processing server 10 at the time of payment of a specific product, by the promotion information interface application 4; c) activating a real-time discount rate selection service program for each user, by the promotion processing server 10; d) automatically updating information on a remaining accumulated discount rate over time, by the promotion processing server 10; e) receiving a selection signal for a specific discount rate from the promotion information interface application 4, by the promotion processing server 10; f) determining whether the remaining accumulated discount rate is present at the time of receiving the selection signal for the specific discount rate, by the promotion processing server 10; and g) providing the discount rate to the user when the remaining accumulated discount rate is present, by the promotion processing server 10.

Preferably, the method further includes: before the step a), receiving and registering information on what percentage of the discount rate is provided when a sale occurs from the affiliate terminal 6 occurs, by the promotion processing server 10.

Preferably, the method further includes: before the step a), registering a plurality of different backup promotion data in which the remaining accumulated discount rate is automatically changed, by the promotion processing server 10.

Preferably, the step b) is a step of transferring the affiliate information, purchase product information, and price of product information to the promotion processing server 10, by any one of the promotion information interface application 4, the affiliate terminal 6 and the payment processing server 8.

Preferably, the step c) further includes: extracting any one backup promotion data classified so that the discount rates are the same as each other and the price of the product belongs to a predetermined group when a sale occurs, by the promotion processing server 10. Preferably, in the step d), when a predetermined number of products are promoted instead of the discount rate, the promotion processing server 10 processes so as to subtract the predetermined number of products over time.

Preferably, in the step d), the promotion processing server 10 extracts any one backup promotion data and processes so as to automatically change the remaining accumulated discount rate according to the extracted data.

Preferably, the step (f) further includes: when the remaining accumulated discount rate is not present, displaying that the accumulated discount rate has been exhausted and displaying that the discount rate obtainment has failed, by the promotion processing server 10.

Preferably, the method further includes: after the step g), separately collecting information on the discount rate selected by the user in real time, and generating and registering new backup promotion data, by the promotion processing server 10.

Preferably, the step c) further includes: performing blind processing for hiding information on the remaining accumulated discount rate in a specific section of the backup promotion data, by the promotion processing server 10; and processing so as to guarantee a predetermined minimum discount rate when the user generates a selection signal in the blind processing section, by the promotion processing server 10.

Preferably, the step c) further includes: processing so as to output a news or an advertisement while hiding the information on the remaining accumulated discount rate in the specific section of the backup promotion data, by the promotion processing server 10; and processing so as to guarantee the predetermined minimum discount rate when the user generates the selection signal in the processing section, by the promotion processing server 10.

Preferably, the step d) further includes: processing so as to automatically exhaust a predetermined discount rate (or discount cost) for each discount section previously grouped, by the promotion processing server 10.

Preferably, the method further includes: after the step g), processing so as to add reward costs for an advertisement access to an accumulated discount costs, by the promotion processing server 10.

### Advantageous Effects

In accordance with the payment-linked promotion processing system and method thereof according to the present invention, since a user selects and receives a predetermined discount rate in real time, among discount rates that vary over time when purchasing products or services, it is possible to contribute to effective consumption promotion. In addition, even if one user participates in the service using backup promotion data, an exciting discount rate selection service can be performed, and as a result, the discount rate selection opportunity can be provided to a larger number of users.

### DESCRIPTION OF DRAWINGS

FIG. 1 is a schematic view illustrating a configuration of a payment-linked promotion processing system according to a first embodiment of the present invention.

FIG. 2 is a diagram illustrating a state of classifying promotional processing groups through the payment-linked promotion processing system according to the first embodiment of the present invention.

FIG. 3 is a diagram illustrating a state of real-time promotion processing through the payment-linked promotion processing system according to the first embodiment of the present invention.

FIG. 4 is a block diagram illustrating a configuration of a promotion processing server included in the payment-linked promotion processing system according to the first embodiment of the present invention.

FIG. 5 is a diagram illustrating a state of performing blind processing on a remaining discount rate through a payment-linked promotion processing system according to a second embodiment of the present invention.

FIG. 6 is a diagram illustrating a state of outputting information through a payment-linked promotion processing system according to a third embodiment of the present invention.

FIG. 7 is a diagram illustrating a state in which a predetermined amount of exhaustion money is set for each percentage section through a payment-linked promotion processing system according to a fourth embodiment of the present invention.

### BEST MODE

Hereinafter, a payment-linked promotion processing system according to a first embodiment of the present invention will be described in detail with reference to the accompanying drawings.

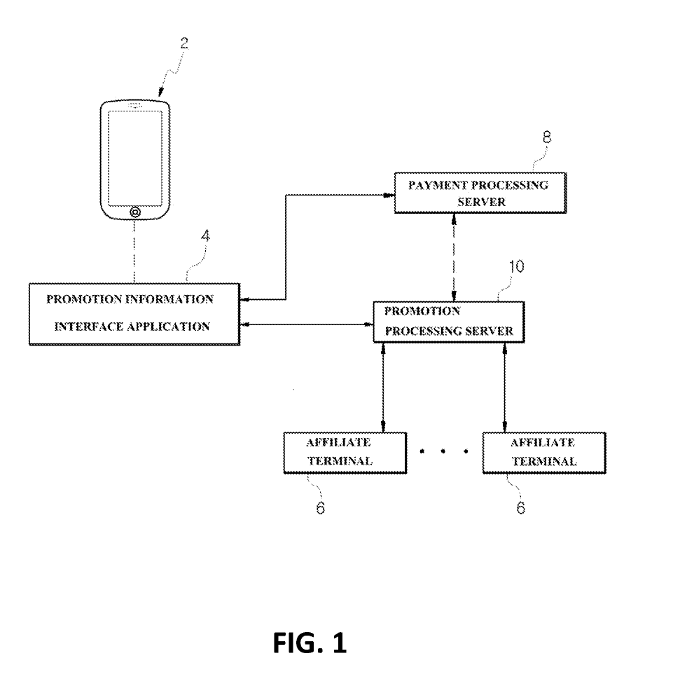

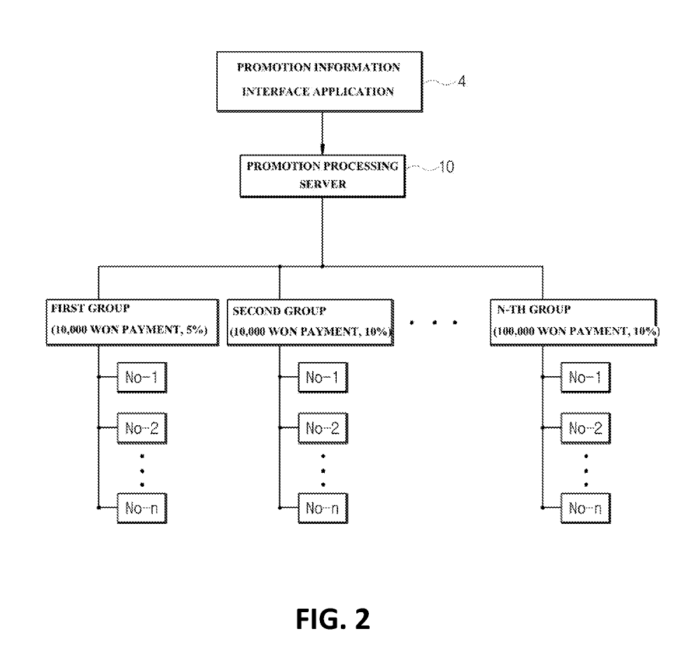

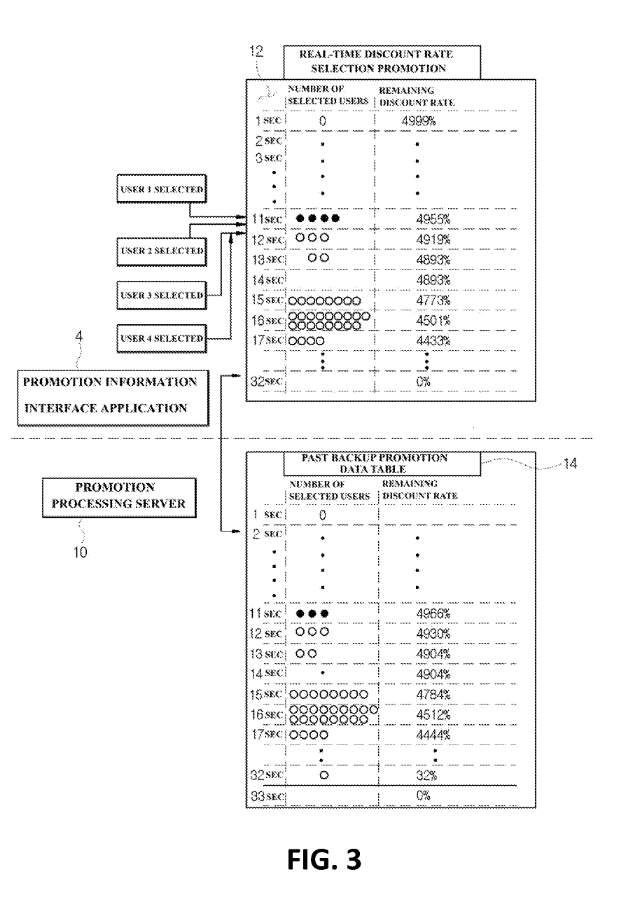

FIG. 1 is a schematic view illustrating a configuration of a payment-linked promotion processing system according to a first embodiment of the present invention, FIG. 2 is a diagram illustrating a state of classifying promotional processing groups through the payment-linked promotion processing system according to the first embodiment of the present invention, and FIG. 3 is a diagram illustrating a state of real-time promotion processing through the payment-linked promotion processing system according to the first embodiment of the present invention.

Referring to FIGS. 1 to 3, the payment-linked promotion processing system according to the first embodiment of the present invention is a system in which affiliates set to provide a fixed discount rate every time a sale occurs are classified for each discount rate; and a discount rate that is provided each time when a user purchases a product is accumulated to use as a financial resource, and purchasers can competitively select and determine the discount rate by themselves in real-time until when the predetermined accumulated discount rate is entirely exhausted, thereby inducing rapid consumption promotion by allowing sellers to process a discount on the determined discount rate

More specifically, the payment-linked promotion processing system according to the first embodiment of the present invention includes: a user terminal 2 configured to allow a user to participate in a real-time discount rate selection service every time the user pays a price of a product, generate a selection signal for selecting a specific discount rate desired by the user to a promotion processing server 10 after participating in the real-time discount rate selection service until when an accumulated discount rate is exhausted, and allow the user to confirm information on discount rate processing; an affiliate terminal 6 configured to set information in the promotion processing server 10 so as to provide a predetermined percentage of the price of the product as a financial resource of the discount rate when the user pays the price of the product; and the promotion processing server 10 configured to receive information on what percentage of the discount rate is provided as a financial resource of the real-time discount rate selection service when a sale occurs from the affiliate terminal 6 occurs and register the received information therein, perform processing of the real-time discount rate selection service of the user in real time, receive a selection signal for a specific discount rate of the user to pay the discount rate to the user, subtract an amount as much as the paid discount rate from a total accumulated discount rate, and provide information on a remaining discount rate.

In the payment-linked promotion processing system according to the first embodiment of the present invention, when a plurality of affiliates provide a predetermined discount rate to a management company on condition that the affiliates participate in the real-time discount rate selection service, the discount rates are accumulated and used as the financial resource of the real-time discount rate selection service.

Herein, the affiliate provides the predetermined discount rate to the management company at the time of a sale occurring. Therefore, the discount rates provided by all the affiliates are actually accumulated at a time in the future after the user makes a payment. That is, when a first user tries to make a payment at an affiliate A, a discount rate of a product to be paid in the future by a second user who has not yet paid the price of the product is not included in the real-time discount rate selection service for the product paid by first user. However, when the first user participates in the real-time discount rate selection service, the promotion processing server 10 previously adds the discount rate of the product to be paid in the future by the second user to the accumulated discount rate.

For this purpose, the users who want to participate in the real-time discount rate selection service are classified depending on each price of the products and the discount rates provided by the affiliates, so as to allow the users to participate in the group belonging to the same classification. For example, when a user who purchases a product that provides a discount rate of 10% for a product payment of 10,000 won participates in the real-time discount rate selection service, and similarly, if other users purchase the product that provides a discount rate of 10% for the product payment of 10,000 won, the other users also may participate in the real-time discount rate selection service in the same group.

In other words, as illustrated in FIG. 2, when a user activates a promotion information interface application 4 to access the promotion processing server 10 and generates selection signals of a payment amount and an affiliate, the promotion processing server 10 searches for a group classified depending on the discount rate provided by the affiliate and the payment amount of the user, extracts any one of a plurality of backup promotion data belonging to the searched group, and performs the ‘real-time discount rate selection service’ according to the extracted backup promotion data.

Further, during the real-time discount rate selection service, in a state in which the discount rate of the ‘discount rate selection service’ is automatically increased over time, for a service that the user selects and obtains the desired discount rate, if there is no accumulated remaining discount rate basically, a user who has not yet selected the discount rate loses an opportunity of selecting the discount rate.

Therefore, the basic structure of the payment-linked promotion processing system is that a plurality of users gather in a specific time zone to perform the ‘discount rate selection service.’ In the present invention, the ‘real-time discount rate selection service’ that provides a ‘discount rate selection service’ in real time may be performed.

For this purpose, the payment-linked promotion processing system according to the first embodiment of the present invention allows the remaining discount rate, which is automatically accumulated through a promotion table previously constructed therein, to be changed over time.

More specifically, the real-time discount rate selection service is automatically processed so that the discount rate (or discount cost) that can be selected by the user is automatically and constantly decreased over time, and the total accumulated discount rate is decreased according to selection of other users.

That is, even if one user tries to access the promotion processing server 10 and participate in the ‘real-time discount rate selection service,’ the remaining discount rate accumulated over time is automatically changed as previously programmed therein. Therefore, the user may recognize that a plurality of users are simultaneously participating in the ‘real-time discount rate selection service,’ and may participate in the service while feeling psychological tension.

When participating in the above-described ‘real-time discount rate selection service,’ the user generates a discount rate selection signal through the user terminal 2. The selection signal for the discount rate of the user can be set in the promotion processing server 10 so as to be generated after or before the payment for the price of the product.

That is, the user may participate in the ‘real-time discount rate selection service’ after payment of the price of the product or may participate in the ‘real-time discount rate selection service’ before the payment of the price of the product.

Accordingly, the user terminal 2 or the affiliate terminal 6 may transmit payment information of the user to the promotion processing server 10, and before the payment, the user terminal 2 or the affiliate terminal 6 transmits information on temporary payment or payment reservation to the promotion processing server 10.

At this time, the user terminal 2 includes the promotion information interface application 4 installed therein to be automatically connected to the promotion processing server 10 at the time of activating, and configured to input payment information for a specific product, generate a selection signal for the specific discount rate, and receive information on whether the discount rate is obtained from the promotion processing server 10 and output the received information.

The promotion information interface application 4 is configured to output an application icon to the user terminal 2. When activating the promotion information interface application 4 by clicking the application icon, the promotion information interface application is automatically connected to the promotion processing server 10.

In this state, the promotion processing server 10 transmits information on affiliates located near the user based on location information thereof to the promotion information interface application 4, thereby outputting the affiliate information on the screen of the user terminal.

Meanwhile, the real-time discount rate selection service may be provided so as to select a specific number of products instead of the total accumulated discount rate. However, also in this case, the user may selectively click a discount rate which is increased in the same manner. For example, if a user selects a discount rate of 20%, one of the accumulated products will be exhausted and the user will have to pay 80% of the price thereof, excluding 20%.

In addition, as described above, the promotion processing server 10 previously registers a plurality of backup promotion data for financial resource exhaustion for each selectable discount rate, so as to provide the real-time discount rate selection service to the user. In this state, when the user participates in the real-time discount rate selection service, any one backup promotion data is randomly extracted to apply it to the user.

At this time, the backup promotion data are promotion data in the past for the desired discount rates selected by a plurality of users participating in the same time zone, so that the discount rate that can be selected by the users is changed over time and the remaining accumulated discount rate is decreased.

Meanwhile, when the user selects a specific discount rate, if the number of users who have already selected the discount rate exceeds the number of past backup promotion data, the promotion processing server 10 processes the backup promotion data so that the number of users matched with every higher discount rate is gradually decreased one by one.

In other words, referring to FIG. 3, a past backup promotion data table 14 is arranged on a lower side thereof, and a screen 12 of performing the real-time discount rate selection promotion service is displayed on an upper side thereof.

More specifically, the past backup promotion data table 14 is constructed in the promotion processing server 10, and the screen 12 of performing the real-time discount rate selection promotion service is output on the screen of the user terminal 2.

At this time, when any one user selects a discount rate of 11%, and if three other users have already selected the discount rate of 11%, the past backup promotion table 14 has a past record indicating that the discount rate of 11% was selected by three users. However, when four users select the discount rate of 11%, the number of users is adjusted in such a way that one user matched to the discount rate of 11% is moved from a discount rate of 12% to display four users, and then another user is moved from a discount rate of 13% to the discount rate of 12%.

Therefore, the promotion processing server 10 processes so that the number of users matched to the higher discount rate is gradually decreased one by one.

The payment-linked promotion processing system according to the first embodiment of the present invention configured as described above may allow the users to participate in the real-time discount rate selection service so as to select the discount rate in real time, by using the backup promotion data for the discount rate selection promotion service in which a large number of users who actually gathered at a predetermined time in the past select the discount rate changed over time.

Therefore, based on the backup promotion data table 14, a predetermined number of users may participate in the service in real time and select a specific discount rate. For example, when 100 users participate in the backup promotion data table 14 and only 80 users may obtain the discount rate, the backup promotion data table 14 can be used until the total number of users participating in the service in real time reaches 80 in total.

At this time, a plurality of backup promotion data tables 14 are constructed in the promotion processing server 10. Therefore, a considerable number of users can participate in the real-time promotional discount rate selection service.

Meanwhile, the promotion processing server 10 may separately collect discount rate data selected by users participating in the real-time promotional discount rate selection service to create a new backup promotion data table 14, and accumulate the table, thus to generate big data on the newly selected discount rates and manage by accumulating.

Therefore, the promotion processing server 10 may process to extract any one backup promotion data whose processing has not been completed according to a payment order of the users, and apply it to the discount rate selection service of the user.

Meanwhile, in accordance with the payment-linked promotion processing system according to the first embodiment of the present invention, a plurality of users may participate in the discount rate selection service at a predetermined time and perform the same. The promotion processing server 10 may process so that a plurality of users participate in the discount rate selection service at a predetermined time.

Meanwhile, the promotion processing server 10 may receive processing information on the payment amount of the affiliate from a payment processing server 8 which is provided in a credit card company or a financial company to perform payment processing of the affiliates, by interworking with the payment processing server 8.

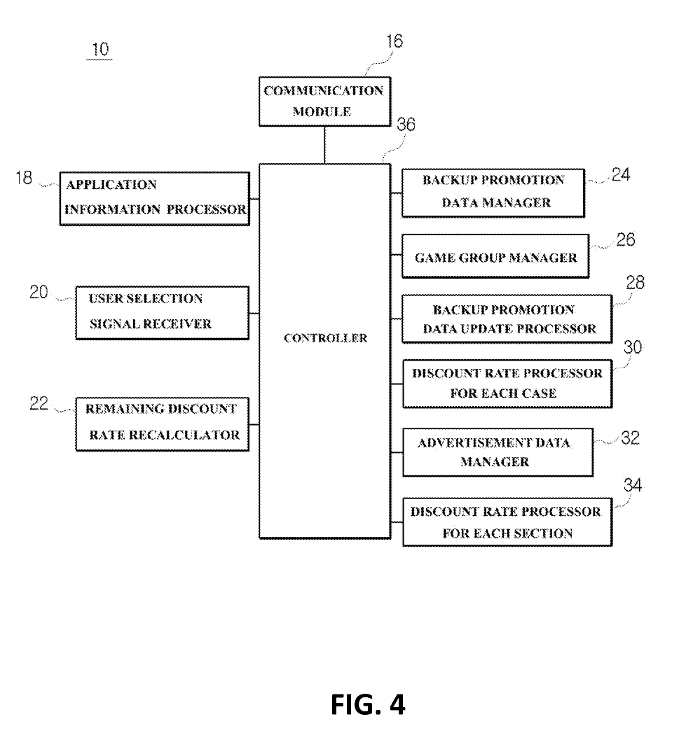

FIG. 4 is a block diagram illustrating a configuration of a promotion processing server included in the payment-linked promotion processing system according to the first embodiment of the present invention.

Referring to FIG. 4, the promotion processing server included in the payment-linked promotion processing system according to the first embodiment of the present invention includes a communication module 16 configured to communicate with the user terminal 2, the affiliate terminal 6, or the payment processing server 8; an application information processor 18 configured to manage identification information of the promotion information interface application 4 installed in the user terminal 2, and process information on participation of the service and payment information of the user; and a user selection signal receiver 20 configured to receive a selection signal for a specific discount rate of the user when participating in the service.

In addition, the promotion processing server 10 includes a remaining discount rate recalculator 22 configured to perform a recalculation on the entire remaining accumulated discount rate according to a discount rate selected by the user; a backup promotion data manager 24 configured to register the number of users who select the discount rates by matching with each discount rate, and manage backup promotion data registered so as to be matched with the remaining accumulated discount rate for each discount rate; and a controller 36 configured to, when requesting the real-time discount rate selection service from the user, extract any one promotional backup data, perform processing of changing the remaining accumulated discount rate over time as the promotional backup data, and control so as to pay the discount rate by determining whether the remaining accumulated discount rate is present at the time of receiving information on the discount rate selected by the user.

In addition, the promotion processing server 10 includes a game group manager 26 configured to classify the backup promotion data for financial resource exhaustion according to information on what percentage of the discount rate is provided as a financial resource by the affiliates of a company and what price of a payment amount paid by the user at the time of payment of the user, and previously register the classified backup promotion data.

In addition, the promotion processing server 10 further includes a backup promotion data update processor configured to separately collect information on the discount rate selected by the user, and generate and register new backup promotion data when performing the service through each backup promotion data.

The function and operation of the payment-linked promotion processing system according to the first embodiment of the present invention having the above-described configuration will be described in detail with reference to the accompanying drawings.

First, the promotion processing server 10 included in the payment-linked promotion processing system according to the first embodiment of the present invention receives and registers information on what percentage of the discount rate is provided when a sale occurs from the affiliate terminal 6.

In addition, the promotion processing server 10 registers a plurality of different backup promotion data in which the remaining accumulated discount rate is automatically changed. That is, the promotion processing server 10 has data previously programed therein to constantly increase the discount rate over time and irregularly decrease the remaining accumulated discount rate according to the discount rate selected by the user, so as to support the service in real time when the user requests the service for selecting the promotional discount rate. Otherwise, it is possible to actually utilize past backup promotion data.

That is, the backup promotion data are recorded with discount rates which are selected by a plurality of users who gather at a predetermined time and are changed over time, the accumulated discount rate changed thereby, and discount rates selected by the users until when the accumulated discount rate is entirely exhausted.

In this state, when the user activates the promotion information interface application 4 of the user terminal 2, the promotion information interface application 4 is automatically connected to the promotion processing server 10.

Then, the promotion processing server 10 receives location information of the user from the promotion information interface application 4 thereof, extracts affiliate information of affiliates near the user, and transmits the extracted affiliate information to the promotion information interface application 4.

Next, the user may access information of the product or service among the affiliate information, and perform a temporary payment or payment for the specific product.

At the time of payment of the specific product, the affiliate information and purchase product information may be transmitted to the promotion processing server 10 by the promotion information interface application 4, and the affiliate information, purchase product information, and price of product information may be transmitted to the promotion processing server 10, by any one of the promotion information interface application 4, the affiliate terminal 6 and the payment processing server 8.

When the payment information is transmitted, the promotion processing server 10 activates the real-time discount rate selection service program for each user. As illustrated in FIG. 2, the promotion processing server 10 extracts any one backup promotion data classified so that the discount rates are the same as each other and the price of the product belongs to a predetermined group when a sale occurs.

Then, the promotion processing server 10 may apply the backup promotion data to the user so as to select the specific discount rate, and automatically updates information on a remaining accumulated discount rate over time. Then, an update processing state is output on the screen of the user terminal 2 through the promotion information interface application 4.

In other words, the promotion processing server 10 extracts any one backup promotion data and processes so as to automatically change the remaining accumulated discount rate according to the extracted data.

Therefore, the user may determine whether he or she selects any discount rate while viewing the discount rate change information and the information on the remaining accumulated discount rate.

Meanwhile, in this process, when a predetermined number of products are promoted instead of the discount rate, the promotion processing server 10 may process so as to subtract the predetermined number of products over time.

At this time, when the user selects any one of the discount rates, the promotion processing server 10 receives a selection signal for the specific discount rate from the promotion information interface application 4, and the promotion processing server 10 determines whether the remaining accumulated discount rate is present at the time of receiving the selection signal for the specific discount rate.

When the remaining accumulated discount rate is present, the promotion processing server provides the discount rate to the user, and performs subsequent payment processing with the affiliate.

Meanwhile, when the remaining accumulated discount rate is not present, the promotion processing server 10 displays that the accumulated discount rate has been exhausted and displays that the discount rate obtainment has failed.

In the real-time discount rate selection service according to the present invention, the user cannot know at what point that the remaining accumulated discount rate is entirely exhausted, such that the user can enjoy a fun of the service with increased tension.

Meanwhile, the promotion processing server 10 may separately collect information on the discount rate selected by the user in real time, and generate and register new backup promotion data.

Hereinafter, a payment-linked promotion processing system according to a second embodiment of the present invention will be described in detail with reference to the accompanying drawings.

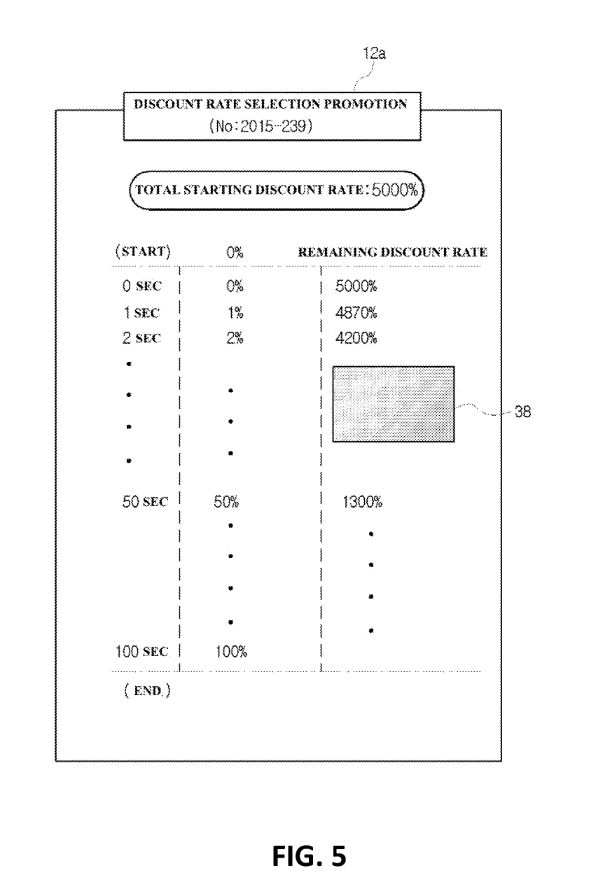

FIG. 5 is a diagram illustrating a state of performing blind processing on a remaining discount rate through a payment-linked promotion processing system according to a second embodiment of the present invention.

Referring to FIG. 5, the payment-linked promotion processing system according to the second embodiment of the present invention performs blind processing so as not to display the remaining discount rate, when purchasers competitively select discount rates by themselves until when the accumulated discount rate provided by sellers is entirely exhausted. Thereby, it is possible to enhance the tension of the user, increase the fun, and provide discount benefits to more users by inducing the user to select the discount rate early.

In accordance with the payment-linked promotion processing system according to the second embodiment of the present invention, the discount rate selection service is performed from a time when the user participates in the service until when all the accumulated discount rate is entirely exhausted. The payment-linked promotion processing system according to the second embodiment of the present invention may start the service in a state in which all users are connected to the promotion processing server 10 at a specific time or may start the service in a state in which the users are individually connected to the promotion processing server 10 in real time.

At this time, the payment-linked promotion processing system according to the second embodiment of the present invention is characterized in that blind processing is performed so that the remaining discount rate is not displayed in a predetermined section (or a predetermined time) after the service starts.

Although the blind processing is performed in only a predetermined section for the remaining discount rate, when the user passes the blind processed section, the user feels a tension that the remaining accumulated discount rate may be entirely exhausted. Therefore, in a blind processing section 38, it is possible to induce more users to click and more users to select the discount rate in a lower discount rate section. As a result, more users have an opportunity to be provided with the discount rate.

Preferably, a screen 12a of performing a discount rate selection promotion service is output on a screen of the user terminal 2. The blind processing section 38 output in a predetermined section on the screen is typically set in a previous section of a time in which the discount rate point selected by the user is highest at a discount rate interval of about 10%. As a result, it is possible to induce more users to select the discount rate.

That is, for example, if the highest discount rate section selected by the user is a 25% section, it is preferable to set the blind processing section in a discount rate range of 15% to 24%.

For this purpose, the payment-linked promotion processing system according to the second embodiment of the present invention includes a promotion processing server 10. The promotion processing server 10 further includes a discount rate processor for each case 30 configured to perform blind processing for hiding information on the remaining accumulated discount rate in a specific section of the backup promotion data, process so as to guarantee a predetermined minimum discount rate when the user generates a selection signal in the blind processing section 38, or process so as to output a news or an advertisement while hiding the information on the remaining accumulated discount rate in the specific section of the backup promotion data, and process so as to guarantee the predetermined minimum discount rate when the user generates the selection signal in the processing section.

That is, when the user participates in the discount rate selection promotion service and generates a selection signal for a specific discount rate in the blind processing section 38, if the remaining accumulated discount rate is present in the specific discount rate section selected by the user, the promotion processing server 10 provides the selected discount rate to the user. However, when the user further generates a selection signal in the blind processing section 38, even if the remaining accumulated discount rate has already been entirely exhausted from the specific discount rate of the blind processing section 38, it is possible to set the promotion processing server 10 to provide the discount rate selected by the user.

With this type of payment, more users will want to select a discount rate that is assigned to the blind processing section 38.

Such a structure may be equally applied to a case in which the user participates in the discount rate selection promotion service in real time.

Hereinafter, a payment-linked promotion processing system according to a third embodiment of the present invention will be described in detail with reference to the accompanying drawings.

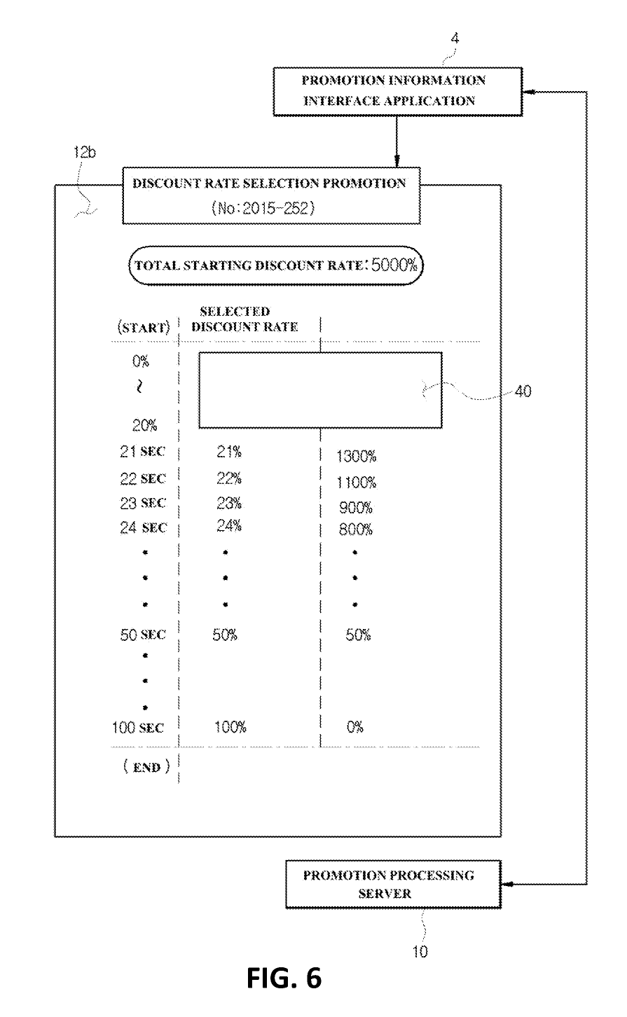

FIG. 6 is a diagram illustrating a state of outputting information through the payment-linked promotion processing system according to the third embodiment of the present invention.

Referring to FIG. 6, the payment-linked promotion processing system according to the third embodiment of the present invention induces purchasers to competitively select discount rates until when the accumulated discount rate provided by the sellers is entirely exhausted. In this system, advertisement and news information may be output in an initial section that the user does not select as well, and access costs for the advertisement and news may be input as an additional financial resource to enhance a tension of the user, thereby increasing the fun of the user and the financial resources to provide discount benefits to more users.

That is, when a user participates in the discount rate selection promotion service according to the present embodiment, the discount rate that can be selected by the user is proportionally increased from the first 0 seconds after the discount rate selection promotion service starts. Of course, the user's selection rate is low in a lower discount rate section such as an initial 1%, 2% . . . and the like.

Therefore, in the payment-linked promotion processing system according to the third embodiment of the present invention, an advertisement output area 40 is arranged in the lower discount rate section. That is, when the promotion information interface application 4 is activated, the promotion processing server 10 outputs the advertisement output area 40 in a predetermined section on a screen 12b of performing a discount rate selection promotion service displayed on the user terminal 2 as illustrated in FIG. 6.

When the user accesses the advertisement output in the advertisement output area 40, the financial resource at this time may be included as a financial resource of the discount rate selection promotional service in which the user participates, and may be accumulated as an individual accumulated money for each user who accesses the advertisement.

For this purpose, the promotion processing server 10 further includes an advertisement data manager 32 configured to manage news or advertisement data so that a news or an advertisement may be output while hiding the information on the remaining accumulated discount rate in the specific section of the backup promotion data.

That is, the advertisement data manager 32 included in the promotion processing server 10 transfers the extracted advertisement data to the promotion information interface application 4 while managing a plurality of advertisement data or news data. Therefore, the advertisement data or the news data are output in the advertisement output area 40 on the screen as illustrated in FIG. 6, which is output by activating the promotion information interface application 4.

Meanwhile, the promotion processing server 10 calculates reward costs for an advertisement access in the advertisement output area 40 so as to be added to the accumulated discount costs.

Likewise, since the remaining accumulated discount rate is not exposed in the advertisement output area 40, it cannot be predicted at all when the remaining accumulated discount rate that can be selected by the user is exhausted.

Therefore, when the user participates in the discount rate selection promotion service and generates a selection signal for a specific discount rate in the advertisement output area 40, if the remaining accumulated discount rate is present in the specific discount rate section selected by the user, the promotion processing server 10 provides the selected discount rate to the user. However, when the user further generates a selection signal in the advertisement output area 40, even if the remaining accumulated discount rate has already been entirely exhausted from the specific discount rate of the advertisement output area 40, it is possible to set the promotion processing server 10 to provide the discount rate selected by the user.

With this type of payment method, more users will want to select a discount rate that is assigned to the advertisement output area 40.

Such a structure may be equally applied to a case in which the user participates in the discount rate selection promotion service in real time.

Hereinafter, a payment-linked promotion processing system according to a fourth embodiment of the present invention will be described in detail with reference to the accompanying drawings.

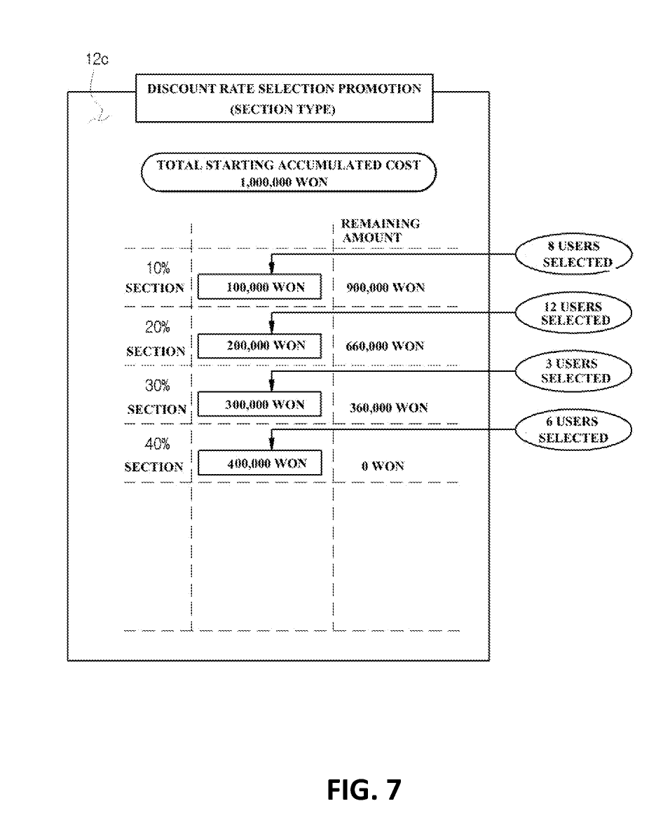

FIG. 7 is a diagram illustrating a state in which a predetermined amount of exhaustion money is set for each percentage section through the payment-linked promotion processing system according to the fourth embodiment of the present invention.

Referring to FIG. 7, the payment-linked promotion processing system according to the fourth embodiment of the present invention divides a discount rate that can be selected by the user into a plurality of sections, and registers predetermined financial resources (discount rates) for each divided section by previously matching thereto, such that even if a selection for the discount rate of the section is the set discount rate or less, the matched discount rate is automatically subtracted.

In the payment-linked promotion processing system according to the fourth embodiment of the present invention, even if there is no selection of the user in a section in which the discount rate is small, the remaining discount rate seems to be reduced. Therefore, it is possible to enhance the tension of the user, thereby further increasing the fun of the user, and more users generate selection signals at a low discount rate. Thus, ultimately, the exhaustion of financial resources may be delayed, thereby allowing more users to be provided with the discount rate.

For this purpose, the promotion processing server 10 further includes a discount rate processor for each section 34 configured to process so as to automatically exhaust a predetermined discount rate (or discount cost) for each specific discount section.

Therefore, in accordance with the payment-linked promotion processing system according to the fourth embodiment of the present invention, the discount rate that can be selected by the user in the promotion processing server 10 is previously divided into a plurality of groups, and discount rates or discount costs to be forcibly exhausted are matched for each discount rate group.

In this state, referring to FIG. 7, when the user accesses the promotion processing server 10 to perform the discount rate selection promotion service and a selection signal is generated from any one discount rate group (for example, a 10% discount rate group), update processing on the remaining accumulated discount rate or the discount costs is performed. For example, if a discount rate group that can be selected by the user when purchasing a 100,000 won product is the 10% discount rate group, and 8 users generate selection signals, since 10% of 100,000 won is 10,000 won and a total of 8 users have selected a 10% discount rate, 80,000 won will be exhausted. However, since an amount set in the 10% discount rate group as a forced exhaustion amount is 100,000 won, 100,000 won is exhausted from one million won of a total starting accumulated cost, such that the remaining amount is displayed as 900,000 won.

Then, if 12 users select the discount rates in a 20% section, although the forced exhaustion amount is set as 200,000 won, a total amount to be paid to 12 users is 240,000 won. Therefore, if subtracting 240,000 won which is an amount to be paid to 12 users from 900,000 won which is the remaining amount, the remaining amount is displayed as 660,000 won.

As a result, in accordance with the payment-linked promotion processing system according to the fourth embodiment of the present invention, the user can confirm that the remaining accumulated amount displayed on the screen is rapidly decreased through the discount rate forced exhaustion structure. This structure allows more users to be selected in the lower discount rate, thereby ultimately providing an opportunity for more users to select the discount rates.

Meanwhile, although the payment-linked promotion processing system and method thereof according to the embodiments of the present invention have been described, the present invention is not limited thereto, and it will be understood by those skilled in the art that various modifications and variations may be made therein without departing from the scope and technical gist of the present invention as defined by the appended claims.

### DESCRIPTION OF REFERENCE NUMERALS

2: User terminal
4: Promotion information interface application
6: Affiliate terminal
8: Payment processing server
10: Promotion processing server

1. A payment-linked promotion processing system comprising:
a user terminal 2 configured to allow a user to participate in a real-time discount rate selection service every time the user pays a price of a product, generate a selection signal for selecting a specific discount rate desired by the user to a promotion processing server 10 after participating in the real-time discount rate selection service until when an accumulated discount rate is exhausted, and allow the user to confirm information on discount rate processing;
an affiliate terminal 6 configured to set information in the promotion processing server 10 so as to provide a predetermined percentage of the price of the product as a financial resource of the discount rate when the user pays the price of the product; and
the promotion processing server 10 configured to receive information on what percentage of the discount rate is provided as a financial resource of the real-time discount rate selection service when a sale occurs from the affiliate terminal 6 occurs and register the received information therein, perform processing of the real-time discount rate selection service of the user in real time, receive a selection signal for a specific discount rate of the user to pay the discount rate to the user, subtract an amount as much as the paid discount rate from a total accumulated discount rate, and provide information on a remaining discount rate.

2. The payment-linked promotion processing system according to claim 1, wherein the selection signal for the discount rate of the user is set in the promotion processing server 10 so as to be generated before the payment for the price of the product.

3. The payment-linked promotion processing system according to claim 1, wherein the user terminal 2 or the affiliate terminal 6 transmit payment information of the user to the promotion processing server 10.

4. The payment-linked promotion processing system according to claim 1, wherein the user terminal 2 includes a promotion information interface application 4 installed therein to be automatically connected to the promotion processing server 10 at the time of activating, and configured to input payment information for a specific product, generate a selection signal for the specific discount rate, and receive information on whether the discount rate is obtained from the promotion processing server 10 and output the received information.

5. The payment-linked promotion processing system according to claim 1, wherein the real-time discount rate selection service is automatically processed so that the discount rate (or discount cost) that can be selected by the user is automatically and constantly decreased over time, and the total accumulated discount rate is decreased according to selection of other users.

6. The payment-linked promotion processing system according to claim 1, wherein the real-time discount rate selection service is provided so as to select a specific number of products instead of the total accumulated discount rate.

7. The payment-linked promotion processing system according to claim 1, wherein the promotion processing server 10 previously registers a plurality of backup promotion data for financial resource exhaustion for each selectable discount rate, so as to provide the real-time discount rate selection service to the user, and in this state, when the user participates in the real-time discount rate selection service, randomly extracts any one backup promotion data to apply it to the user.

8. The payment-linked promotion processing system according to claim 1, wherein the promotion processing server 10 processes so that a plurality of users participate in the discount rate selection service at a predetermined time.

9. The payment-linked promotion processing system according to claim 1, wherein the promotion processing server 10 includes a game group manager 26 configured to classify the backup promotion data for financial resource exhaustion according to information on what percentage of the discount rate is provided as a financial resource by the affiliates of a company and what price of a payment amount paid by the user at the time of payment of the user, and previously register the classified backup promotion data.

10. The payment-linked promotion processing system according to claim 1, wherein the promotion processing server 10 comprises:
a communication module 16 configured to communicate with the user terminal 2, the affiliate terminal 6, or the payment processing server 8;
an application information processor 18 configured to manage identification information of the promotion information interface application 4 installed in the user terminal 2, and process information on participation of the service and payment information of the user;
a user selection signal receiver 20 configured to receive the selection signal for the specific discount rate of the user when participating in the service;
a remaining discount rate recalculator 22 configured to perform a recalculation on an entire remaining accumulated discount rate according to a discount rate selected by the user;
a backup promotion data manager 24 configured to register the number of users who select the discount rates by matching with each discount rate, and manage backup promotion data registered so as to be matched with the remaining accumulated discount rate for each discount rate; and
a controller 36 configured to, when requesting the real-time discount rate selection service from the user, extract any one promotional backup data, perform processing of changing the remaining accumulated discount rate over time as the promotional backup data, and control so as to pay the discount rate by determining whether the remaining accumulated discount rate is present at the time of receiving information on the discount rate selected by the user.

11. The payment-linked promotion processing system according to claim 1, wherein the promotion processing server 10 receives processing information on the payment amount of the affiliate from a payment processing server 8 which is provided in a credit card company or a financial company to perform payment processing of the affiliates, by interworking with the payment processing server 8.

12. The payment-linked promotion processing system according to claim 1, wherein the promotion processing server 10 further comprises: a backup promotion data update processor 28 configured to separately collect information on the discount rate selected by the user, and generate and register new backup promotion data when performing the service through each backup promotion data.

13. The payment-linked promotion processing system according to claim 1, wherein the promotion processing server 10 further comprises: a discount rate processor for each case 30 configured to: perform blind processing for hiding information on the remaining accumulated discount rate in a specific section of the backup promotion data; process so as to guarantee a predetermined minimum discount rate when the user generates a selection signal in the blind processing section; or process so as to output a news or an advertisement while hiding the information on the remaining accumulated discount rate in the specific section of the backup promotion data; and process so as to guarantee the predetermined minimum discount rate when the user generates the selection signal in the processing section.

14. The payment-linked promotion processing system according to claim 1, wherein the promotion processing server 10 further comprises: an advertisement data manager 32 configured to manage news or advertisement data so as to output a news or an advertisement while hiding the information on the remaining accumulated discount rate in the specific section of the backup promotion data.

15. The payment-linked promotion processing system according to claim 1, wherein the promotion processing server 10 further comprises: a discount rate processor for each section 34 configured to process so as to automatically exhaust a predetermined discount rate (or discount cost) for each specific discount section.

16. The payment-linked promotion processing system according to claim 1, wherein the promotion processing server 10 calculates access costs for an advertisement output area 40 so as to be included in accumulated discount costs.

17. The payment-linked promotion processing system according to claim 7, wherein the backup promotion data are promotion data in the past for the desired discount rates selected by a plurality of users participating in the same time zone, so that the discount rate that can be selected by the users is changed over time and the remaining accumulated discount rate is decreased.

18. The payment-linked promotion processing system according to claim 7, wherein, when the user selects a specific discount rate, if the number of users who have already selected the discount rate exceeds the number of past backup promotion data, the promotion processing server 10 processes the backup promotion data so that the number of users matched with every higher discount rate is gradually decreased one by one.

19. The payment-linked promotion processing system according to claim 7, wherein the promotion processing server 10 processes to extract any one backup promotion data whose processing has not been completed according to a payment order of the users, and apply it to the discount rate selection service of the user.

20. A method of processing payment-linked promotion, comprising:
a) activating a promotion information interface application 4 of a user terminal 2 to be automatically connected to a promotion processing server 10;
b) transmitting affiliate information and purchase product information to the promotion processing server 10 at the time of payment of a specific product, by the promotion information interface application 4;
c) activating a real-time discount rate selection service program for each user, by the promotion processing server 10;
d) automatically updating information on a remaining accumulated discount rate over time, by the promotion processing server 10;
e) receiving a selection signal for a specific discount rate from the promotion information interface application 4, by the promotion processing server 10;
f) determining whether the remaining accumulated discount rate is present at the time of receiving the selection signal for the specific discount rate, by the promotion processing server 10; and
g) providing the discount rate to the user when the remaining accumulated discount rate is present, by the promotion processing server 10.

21. The method of processing payment-linked promotion according to claim 20, further comprising: before the step a), receiving and registering information on what percentage of the discount rate is provided when a sale occurs from the affiliate terminal 6 occurs, by the promotion processing server 10.

22. The method of processing payment-linked promotion according to claim 20, further comprising: before the step a), registering a plurality of different backup promotion data in which the remaining accumulated discount rate is automatically changed, by the promotion processing server 10.

23. The method of processing payment-linked promotion according to claim 20, wherein the step b) is a step of transferring the affiliate information, purchase product information, and price of product information to the promotion processing server 10, by any one of the promotion information interface application 4, the affiliate terminal 6 and the payment processing server 8.

24. The method of processing payment-linked promotion according to claim 20, wherein the step c) further comprises: extracting any one backup promotion data classified so that the discount rates are the same as each other and the price of the product belongs to a predetermined group when a sale occurs, by the promotion processing server 10.

25. The method of processing payment-linked promotion according to claim 20, wherein in the step d), when a predetermined number of products are promoted instead of the discount rate, the promotion processing server 10 processes so as to subtract the predetermined number of products over time.

26. The method of processing payment-linked promotion according to claim 20, wherein in the step d), the promotion processing server 10 extracts any one backup promotion data and processes so as to automatically change the remaining accumulated discount rate according to the extracted data.

27. The method of processing payment-linked promotion according to claim 20, wherein the step (f) further comprises: when the remaining accumulated discount rate is not present, displaying that the accumulated discount rate has been exhausted and displaying that the discount rate obtainment has failed, by the promotion processing server 10.

28. The method of processing payment-linked promotion according to claim 20, further comprising: after the step g), separately collecting information on the discount rate selected by the user in real time, and generating and registering new backup promotion data, by the promotion processing server 10.

29. The method of processing payment-linked promotion according to claim 20, wherein the step c) further comprises:
performing blind processing for hiding information on the remaining accumulated discount rate in a specific section of the backup promotion data, by the promotion processing server 10; and
processing so as to guarantee a predetermined minimum discount rate when the user generates a selection signal in the blind processing section, by the promotion processing server 10.

30. The method of processing payment-linked promotion according to claim 20, wherein the step c) further comprises:
processing so as to output a news or an advertisement while hiding the information on the remaining accumulated discount rate in the specific section of the backup promotion data, by the promotion processing server 10; and
processing so as to guarantee the predetermined minimum discount rate when the user generates the selection signal in the processing section, by the promotion processing server 10.

31. The method of processing payment-linked promotion according to claim 20, wherein the step d) further comprises:
processing so as to automatically exhaust a predetermined discount rate (or discount cost) for each discount section previously grouped, by the promotion processing server 10.

32. The method of processing payment-linked promotion according to claim 20, further comprising: after the step g), processing so as to add reward costs for an advertisement access to an accumulated discount costs, by the promotion processing server 10.
